(19) United States
(12) Patent Application Publication
(10) Pub. No.: US 2023/0333882 A1
(43) Pub. Date: Oct. 19, 2023

(54) SYSTEMS AND METHODS FOR CREATING WORKFLOWS BY CHAINING MICROAPPS IN A WORKSPACE PLATFORM

(71) Applicant: Citrix Systems, Inc., Ft. Lauderdale, FL (US)

(72) Inventors: Ullas Shamasundar, Pompano Beach, FL (US); Anjaneya Padmakar Akondi, Boca Raton, FL (US); Edwin Abraham, Pompano Beach, FL (US); Smruthi Sripathi Bhat, Pompano Beach, FL (US)

(73) Assignee: Citrix Systems, Inc., Ft. Lauderdale, FL (US)

(21) Appl. No.: 17/721,999

(22) Filed: Apr. 15, 2022

(51) Int. Cl. G06F 9/48

(52) U.S. Cl. CPC G06F 9/4881

(57) ABSTRACT

A computer system is provided. The computer system includes a memory and a processor operably coupled to the memory. The processor is configured to receive a set of rules for generating a workflow that chains one or more tasks associated with one or more applications into the workflow; receive an indication of a task to be completed; generate a task-based workflow for the task to be completed based upon the set of rules, wherein the task-based workflow provides a user with an indication of a task to be completed and which of the one or more applications to use to complete the task; monitor interaction between the user and the task-based workflow; update the task-based workflow to indicate one or more completed tasks based upon the monitored interaction to create an updated workflow; and provide an indication of the updated workflow to the user.

### BACKGROUND

A microapp is a lightweight software application that synchronizes data from one or more complex enterprise applications to provide a user with specific, targeted functionality. Microapps provide this functionality in a streamlined manner via a relatively simple, contained interface. Generally, a user can access the functionality provided by a microapp without needing to launch a new application or toggle to a different application window. Microapps thus allow users to complete simple tasks within the context of an existing application environment, such as a web browser, a distributed workspace, or other similar context. Microapps also enable a distributed workspace to extend the capabilities of enterprise applications-including “software as a service” (SaaS) applications, web applications, desktop applications, and proprietary applications–through a single interface. In general, a microapp can be used to synchronize data from complex enterprise applications to streamline functionality, and can therefore be understood as a streamlined use case that users can access from within a distributed workspace.

### SUMMARY

In at least one example, a computer system is provided. The computer system includes a memory and at least one processor operably coupled to the memory. The at least one processor is configured to receive a set of rules for generating a workflow that chains one or more tasks associated with one or more applications into the workflow; receive an indication of a task to be completed; generate a task-based workflow for the task to be completed based upon the set of rules, wherein the task-based workflow provides one or more users with an indication of a task to be completed and which of the one or more applications to use to complete the task; monitor interaction between the one or more users and the task-based workflow; update the task-based workflow to indicate one or more completed tasks based upon the monitored interaction to create an updated workflow; and provide an indication of the updated workflow to the one or more users.

Examples of the computer system can include one or more of the following features. In the computer system, the at least one processor being configured to monitor interaction between the one or more users and the task-based workflow can include the at least one processor being further configured to monitor interaction between the one or more users and a microapp associated with at least one task in the task-based workflow; determine that the one or more users have completed the at least one task in the task-based workflow by performing one or more actions within the microapp associated with the at least one task; and receive an indication that the at least one task in the task-based workflow has been completed.

In the computer system, the at least one processor being configured to update the task-based workflow can include the at least one processor being further configured to determine an action taken by at least one of the one or more users; determine at least one additional task to add to the workflow based upon the action taken by the at least one of the one or more users; and update the task-based workflow to include the at least one additional task.

In the computer system, the at least one processor can be further configured to receive an updated set of rules; generate an updated task-based workflow based upon the update set of rules; and provide notification to the one or more users of the updated task-based workflow.

In the computer system, the at least one processor can be further configured to determine an action taken by at least one of the one or more users when completing at least one task in the task-based workflow; determine a recommended task to include in the workflow based upon the action of taken by the at least one of the one or more users; and provide a recommendation to the at least one of the one or more users to include the recommended task in the workflow. In the computer system, the at least one processor being configured to determine a recommended task to include in the workflow can include the at least one processor being further configured to determine a first recommended task based upon the set of rules; determine a second recommended task based upon historic use information for the at least one of the one or more users; determine a third recommended task based upon information for system users other than the at least one of the one or more users; and compare the first recommended task, the second recommended task, and the third recommended task to determine the recommended task to provide to the at least one of the one or more users. In the computer system, the at least one processor being configured to compare the first recommended task, the second recommended task, and the third recommended task can include the at least one processor being further configured to determine a first weighted average associated with the first recommended task; determine a second weighted average associated with the second recommended task; determine a third weighted average associated with the third recommended task; and compare the first weighted average, the second weighted average, and the third weighted average.

In at least one example, a method executed by a computer system to create workflows by chaining microapps in a workspace platform is provided. The method includes receiving a set of rules for generating a workflow that chains one or more tasks associated with one or more applications into the workflow; receiving an indication of a task to be completed; generating a task-based workflow for the task to be completed based upon the set of rules, wherein the task-based workflow provides one or more users with an indication of a task to be completed and which of the one or more applications to use to complete the task; monitoring interaction between the one or more users and the task-based workflow; updating the task-based workflow to indicate one or more completed tasks based upon the monitored interaction to create an updated workflow; and providing an indication of the updated workflow to the one or more users.

Examples of the method can include one or more of the following features. In the method, monitoring the interaction between the one or more users and the task-based workflow can include monitoring interaction between the one or more users and a microapp associated with at least one task in the task-based workflow; determining that the one or more users have completed the at least one task in the task-based workflow by performing one or more actions within the microapp associated with the at least one task; and receiving an indication that the at least one task in the task-based workflow has been completed.

In the method, updating the task-based workflow can include determining an action taken by at least one of the one or more users; determining at least one additional task to add to the workflow based upon the action taken by the at least one of the one or more users; and updating the task-based workflow to include the at least one additional task. The method can further include receiving an updated set of rules; generating an updated task-based workflow based upon the update set of rules; and providing notification to the one or more users of the updated task-based workflow. The method can further include determining an action taken by at least one of the one or more users when completing at least one task in the task-based workflow; determining a recommended task to include in the workflow based upon the action of taken by the at least one of the one or more users; and providing a recommendation to the at least one of the one or more users to include the recommended task in the workflow.

In the method, determining a recommended task to include in the workflow can include determining a first recommended task based upon the set of rules; determining a second recommended task based upon historic use information for the at least one of the one or more users; determining a third recommended task based upon information for system users other than the at least one of the one or more users; and comparing the first recommended task, the second recommended task, and the third recommended task to determine the recommended task to provide to the at least one of the one or more users. In the method, comparing the first recommended task, the second recommended task, and the third recommended task can include determining a first weighted average associated with the first recommended task; determining a second weighted average associated with the second recommended task; determining a third weighted average associated with the third recommended task; and comparing the first weighted average, the second weighted average, and the third weighted average.

In at least one example, a non-transitory computer readable storage medium is provided. The non-transitory computer readable storage medium stores computer executable sequences of instructions to create workflows by chaining microapps in a workspace platform. The sequences of instructions comprising instructions to receive a set of rules for generating a workflow that chains one or more tasks associated with one or more applications into the workflow; receive an indication of a task to be completed; generate a task-based workflow for the task to be completed based upon the set of rules, wherein the task-based workflow provides one or more users with an indication of a task to be completed and which of the one or more applications to use to complete the task; monitor interaction between the one or more users and the task-based workflow; update the task-based workflow to indicate one or more completed tasks based upon the monitored interaction to create an updated workflow; and provide an indication of the updated workflow to the one or more users.

Examples of the non-transitory computer readable storage medium can include one or more of the following features. The instructions to monitor the interaction between the one or more users and the task-based workflow can include instructions to monitor interaction between the one or more users and a microapp associated with at least one task in the task-based workflow; determine that the one or more users have completed the at least one task in the task-based workflow by performing one or more actions within the microapp associated with the at least one task; and receive an indication that the at least one task in the task-based workflow has been completed. The instructions to update the task-based workflow can include instructions to determine an action taken by at least one of the one or more users; determine at least one additional task to add to the workflow based upon the action taken by the at least one of the one or more users; and update the task-based workflow to include the at least one additional task.

In the non-transitory computer readable storage medium, the sequences of instructions can include instructions to receive an updated set of rules; generate an updated task-based workflow based upon the update set of rules; and provide notification to the one or more users of the updated task-based workflow. The sequences of instructions can include instructions to determining an action taken by at least one of the one or more users when completing at least one task in the task-based workflow; determining a recommended task to include in the workflow based upon the action of taken by the at least one of the one or more users; and providing a recommendation to the at least one of the one or more users to include the recommended task in the workflow. The instructions to determine a recommended task to include in the workflow can include instructions to determine a first recommended task based upon the set of rules; determine a second recommended task based upon historic use information for the at least one of the one or more users; determine a third recommended task based upon information for system users other than the at least one of the one or more users; and compare the first recommended task, the second recommended task, and the third recommended task to determine the recommended task to provide to the at least one of the one or more users. The instructions to compare the first recommended task, the second recommended task, and the third recommended task can include instructions to determine a first weighted average associated with the first recommended task; determine a second weighted average associated with the second recommended task; determine a third weighted average associated with the third recommended task; and compare the first weighted average, the second weighted average, and the third weighted average.

Still other aspects, examples and advantages of these aspects and examples, are discussed in detail below. Moreover, it is to be understood that both the foregoing information and the following detailed description are merely illustrative examples of various aspects and features and are intended to provide an overview or framework for understanding the nature and character of the claimed aspects and examples. Any example or feature disclosed herein can be combined with any other example or feature. References to different examples are not necessarily mutually exclusive and are intended to indicate that a particular feature, structure, or characteristic described in connection with the example can be included in at least one example. Thus, terms like “other” and “another” when referring to the examples described herein are not intended to communicate any sort of exclusivity or grouping of features but rather are included to promote readability.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this specification but are not intended as a definition of the limits of any particular example. The drawings, together with the remainder of the specification, serve to explain principles and operations of the described and claimed aspects. In the figures, each identical or nearly identical component that is illustrated in various figures is represented by a like numeral. For purposes of clarity, not every component may be labeled in every figure.

FIG. 1 is a top-level block diagram of an implementation of a system for providing and tracking user interaction with task-based workflows, in accordance with an example of the present disclosure.

FIG. 2 is a block diagram of a workflow platform, in accordance with an example of the present disclosure.

FIG. 3 is a flow diagram of generating and updating a task-based workflow, in accordance with an example of the present disclosure.

FIG. 4 is a flow diagram of providing a recommended task to be included in a task-based workflow, in accordance with an example of the present disclosure.

FIG. 5 is a flow diagram of an example process for tracking and updating user interaction with a task-based workflow, in accordance with an example of the present disclosure.

FIG. 6 is a block diagram of a computing platform configured to perform a process for generating and updating a task-based workflow, in accordance with an example of the present disclosure.

### DETAILED DESCRIPTION

As noted above, microapps provide a user with frequently invoked functionality from a range of different applications via a relatively simple, contained interface. Microapps accomplish this by synchronizing data from a user’s applications in a way that allows the user to access data and functionality provided by an underlying application without actually launching the underlying application or toggling to a different interface. User actions taken within a microapp serve as the basis for inputs provided to an underlying application. From a conceptual standpoint, microapps can thus be understood as unbundling the functionality provided by a user’s applications to provide the user with simplified actions within the user’s preferred working environment, such as a web browser or distributed workspace. Examples of frequently invoked actions that can be streamlined using microapps include submitting helpdesk tickets, approving expense reports, confirming calendar appointments, and reviewing vacation requests.

The wide-ranging productivity and usability benefits of microapps has led to rapid growth in the number of available microapps. However, as the number of microapps has increased, user utilization of and reliance upon microapps has also increased accordingly. As such, a typical user accesses multiple microapps on any normal day, sometimes requiring access to a number of microapps to complete a single task. For example, there are scenarios where a user may require information from one microapp based on a particular trigger in another microapp. This may require logging into a first microapp, checking a particular status and, based on the status, opening another microapp to complete another task. Such constant changing between microapps is not only cumbersome but also lowers productivity. By providing a common view with a clear workflow that integrates status information from various microapps, user efficiency and overall user experience can be improved.

As described herein, systems and methods are provided for allowing applications such as microapps to not only communicate with each other but also provide a unified user interface where a user can access a clean workflow that chains multiple microapps. For example, in a workspace platform, the same authentication token can be used to log into any of the microapps provided on the platform. By using information included in the application programming interfaces (APIs) associated with each of the microapps, specific parameters related to the status of one or more tasks can be fetched. An admin associated with the workspace can define commonly used workflows that would chain micro apps by fetching specific information. As described herein, a workflow can be configured to grow dynamically, and the direction in which the workflow grows can be determined by the information fetched by respective microapps.

For example, different users can access different sets of microapps based upon their roles. For example the set of microapps accessed by a software developer can be different from the set of microapps accessed by a person working in a finance department. So, apart from the common templates provided by the admin, users can also create their own workflows to meet their own professional needs by manually chaining one or more microapps together to form a personalized workflow.

In certain implementations, the workflow platform as described herein can use a publish-subscribe model to subscribe for updates in the microapps involved in the workflow. Each time there is a change in status, the publisher can use a message broker to inform the subscribers associated with the workflow of the update. The workflow platform can then update its own workflow with the latest status. Moreover, in some examples, the workflow platform can be configured to be self-learning. As the workflow platform processes more data, the workflow platform can begin to predict and recommend the next steps in the workflow. Such an implementation would save time for the users as, with use of the workflow, the workflow platform and associated workflow process can become more reliably automated without human intervention.

Thus, and in accordance with at least some examples disclosed herein, systems and methods for generating task-based workflows including multiple users and/or applications/microapps are provided. These systems and methods provide for improved efficiency when tracking user completion of tasks as included in a particular workflow.

As will be understood in view of this disclosure, the systems and methods for generating task-based workflows including multiple users and/or applications/microapps have several advantages over existing methods which rely on a slower, user implemented process for tracking workflow generation and completion. For instance, the systems and methods described herein provide automated notification of tasks to be completed to advance and/or complete a generated workflow.

Examples of the methods and systems discussed herein are not limited in application to the details of construction and the arrangement of components set forth in the following description or illustrated in the accompanying drawings. The methods and systems are capable of implementation in other examples and of being practiced or of being carried out in various ways. Examples of specific implementations are provided herein for illustrative purposes only and are not intended to be limiting. In particular, acts, components, elements, and features discussed in connection with any one or more examples are not intended to be excluded from a similar role in any other examples.

### System Overview

As described herein, a distributed workspace is a software framework for delivering and managing applications, data, and desktops in a consistent and secure manner across multiple devices and locations. The distributed workspace enhances the user experience by streamlining and automating frequently performed tasks, such as browsing web pages, entering data into forms, and retrieving data into applications. The distributed workspace allows users to access functionality provided by multiple applications through a common user interface (UI), including software-as-a-service (SaaS) applications, web applications, desktop applications, enterprise applications, and proprietary applications. Microapps extend the capabilities of these applications in the distributed workspace. The microapp can be configured to perform certain functions that assist the user, such as notifying users when data from a system of record (SoR) is added, changed or otherwise updated. The microapp allows a list of available actions to be curated and presented to a user, thereby allowing the user to interact with an entire suite of diverse applications without leaving the distributed workspace interface.

The wide-ranging productivity and usability benefits of microapps has resulted in a need for tools that make it easy for developers and other end-users to create individually customized microapps. Such development tools streamline the process of identifying frequently invoked actions from applications within the distributed workspace and integrating those actions into the customized microapp. For example, while prebuilt microapp action templates can be directly integrated into a user’s distributed workspace, such microapps may not adequately serve the unique needs of a given user or group of users.

Existing microapp development tools help administrators to develop and deploy a suite of microapps that is tailored to the needs of a particular user or a group of users. This development process remains heavily reliant on human knowledge and intuition to identify the workflows that microapps should facilitate. For example, to create useful microapp integrations, developers should know which applications are frequently used, and more specifically, what application functionality is frequently invoked by specific users. However, in a large organization it is difficult for administrators to customize the workspace for this individualized usage, thus presenting an obstacle to the development of useful microapps.

In a more general sense, the functionality provided by a microapp and the underlying applications that a microapp leverages are often selected based on the subjective judgment of a developer, administrator, or other software engineer. It is often challenging for software engineers to make judgments with respect to which microapp functionality will most likely yield benefits in terms of improved efficiency and streamlined workflows. More specifically, software engineers charged with developing a distributed workspace and the microapp functionality provided therein are often not aware of the application functionality that users in other fields see as most useful. For example, users in the financial services or healthcare industries will likely demand different functionality than software engineers or product managers. Furthermore, constructing microapps requires a high degree of programming skills and effort, so it is not practical for developers to customize microapps for many unique users. An improved approach would allow individual users to customize microapps to suit their needs and make the development process less reliant on software developers and engineers.

In view of the foregoing, a workflow platform, as disclosed herein, allows administrators and users to easily customize, generate, and deploy new workflows configured to integrate functionality from multiple microapps with less specialized skill and effort as compared to existing microapp development techniques.

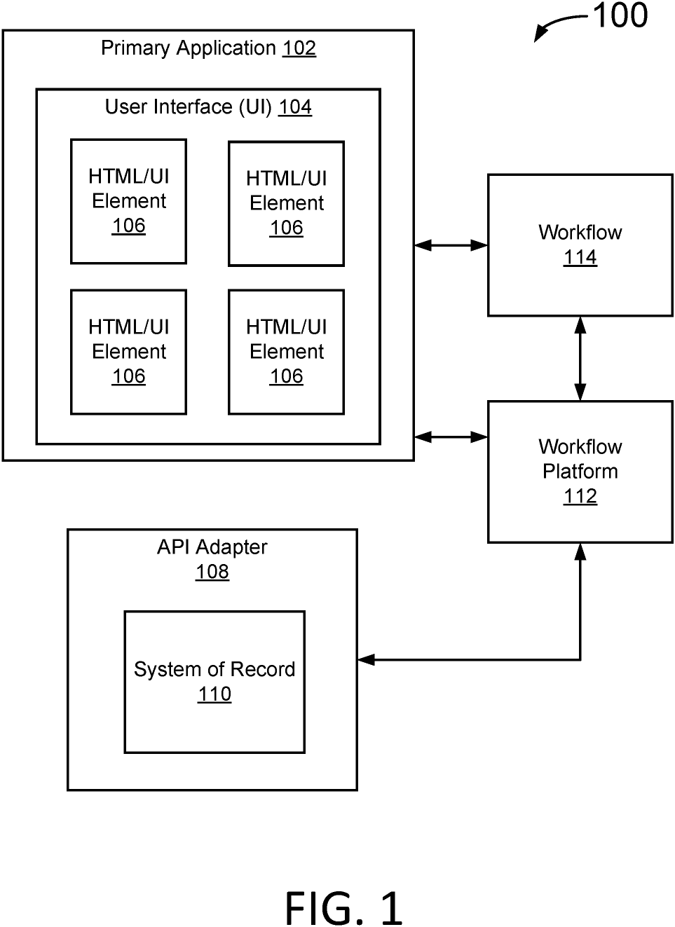

FIG. 1 is an example processing environment 100 including one or more microapps, in accordance with an embodiment of the present disclosure. At least a portion of the processing environment 100 can be implemented within a distributed workspace. Within the processing environment 100 is a primary application 102, which is configured to interact with a system of record (SoR) 110. An example of the primary application 102 is the Citrix Workspace infrastructure. The primary application 102 is configured to provide at least one user interface (UI) 104, which in turn is configured to provide at least one Hypertext Markup Language (HTML) or other UI element 106. For example, the UI element 106 can be an element of a web page displayed via the primary application 102. The processing environment 100 further includes an application programming interface (API) adapter 108 that is configured to interact with the SoR 110, for example, to send data to and receive data from the SoR 110. As will be described in further detail below, the processing environment 100 includes a workflow platform 112 and a workflow 114 that is generated by the workflow platform 112. The workflow platform 112 and the workflow 114 are configured to interact with the primary application 102 and the SoR 110.

The SoR 110 is an information storage system that is an authoritative source of data. An example of a SoR 110 is a computer system that serves data used by websites or other applications for collecting and disseminating information with end users. For instance, a website that provides news stories can display data served by a SoR to the UI 104 of the primary application 102, which executes on or is otherwise provided to a client computing device. The HTML/UI element(s) 106 of the UI 104 are generated based on the data served by the SoR 110.

The workflow 114 is a structured set of instructions for accessing one or more microapps that are configured to perform one or more discrete tasks, sometimes highly targeted to a specific user-interface function. The workflow platform 112 is a specialized module used to generate and configure the workflow 114 based upon, for example, an initial set of rules, user input, historical user data, and other similar input as described herein. The workflow platform 112 provides the ability to manually or automatically identify the UI elements 106 of the UI 104 and generate the workflow 114 based on the UI elements 106, for example, to perform actions when the data associated with the UI element 106 is changed or otherwise updated by the SoR 110 or when the user activates and/or updates the workflow 114. As such, in some examples, the sets of rules described herein can specify initiating events (e.g., changes to data maintained by the SoR 110 and/or UI elements 106) that trigger execution of a rule and one or more workflow tasks queued for completion by the rule execution. Each task, in turn, can be associated with one or more user interactions with certain UI elements 106. The user interactions associated with a task can be required or optional to complete the task, according to some implementations.

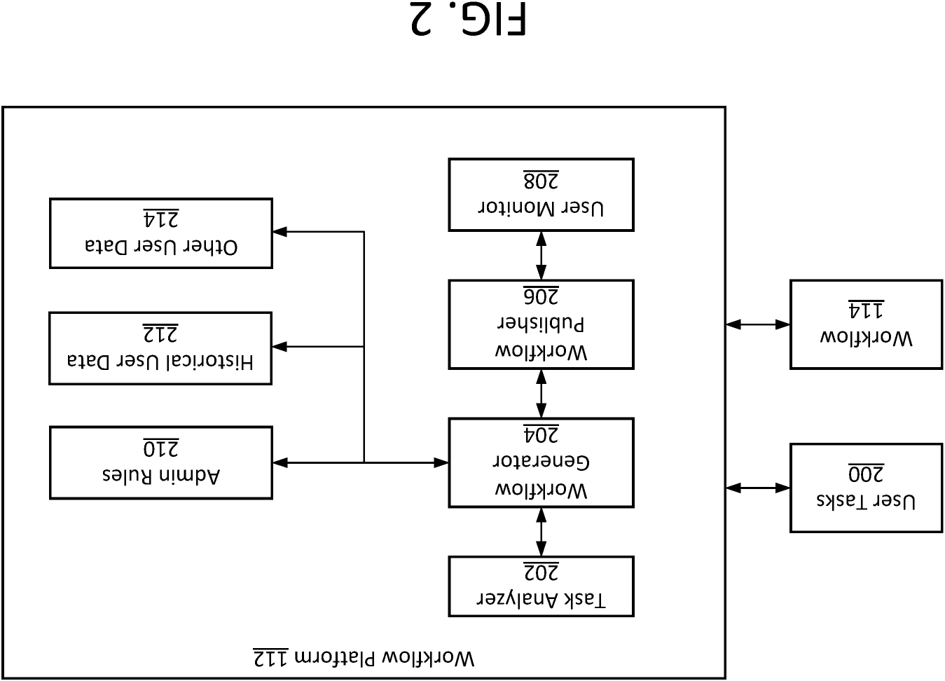

FIG. 2 illustrates an example system diagram of the workflow platform 112 as described herein. As shown in FIG. 2, the workflow platform 112 can be configured to monitor user task information 200 from, for example, the primary application 102 as shown in FIG. 1. The workflow platform 112 can also be configured to output the workflow 114 as shown in FIG. 1 and described above.

As further shown in FIG. 2, the workflow platform 112 can include a task analyzer 202, a workflow generator 204, a workflow publisher 206, and a user monitor 208. In certain implementations, the workflow generator 204 can be operatively coupled to a data structure configured to store, for example, a set of admin rules 210, a set of historical user data 212 (e.g., information related to the user creating or otherwise interacting with the workflow), and a set of other user data 214.

As described herein, the task analyzer 202 can be configured to monitor user activity as included in, for example, the user task information 200 to determine one or more tasks a particular user is trying to accomplish within the primary application 102. For example, the task can be updating an existing document such as a piece of code, perform a scheduling activity, perform a financial planning activity, perform a human resources activity, perform a sales activity, and other similar tasks a user may perform during a typical workday. The task analyzer 202 can be configured to determine a desired end product based upon the user task being performed. For example, if the user is updating a piece of code, the desired end product maybe a document including reviewed and approved code as created by and/or updated by the user’s supervisor.

For example, the task analyzer 202 can be configured to monitor a user’s interaction with a specific application within primary application 102. Based upon the user’s interaction, the task analyzer can determine what desired end product or task the user is attempting to achieve and/or complete. For example, if the user is accessing a human resource management microapp and requesting a day off, the task analyzer can determine that the user’s desired end product is to receive approval for the requested time off. Based upon the determination of the user’s desired end product, the workflow platform 112 can generate a task-based workflow that includes a number of tasks and indications of associated microapps to use to complete those tasks. Upon completion of all tasks contained within the workflow, the system as described hereinbelow can complete the desired end product.

The workflow generator 204 can be configured to receive task specific information from the task analyzer 202. Based upon the task information, the workflow generator 204 can determine a particular workflow including any intervening tasks that may be required to achieve the desired end product. Based upon information received from the task analyzer 202 (e.g., information related to the desired end product), the workflow generator can access one or more resources to determine what specific tasks, and associated microapps, should be listed in the workflow in order to achieve the desired end product.

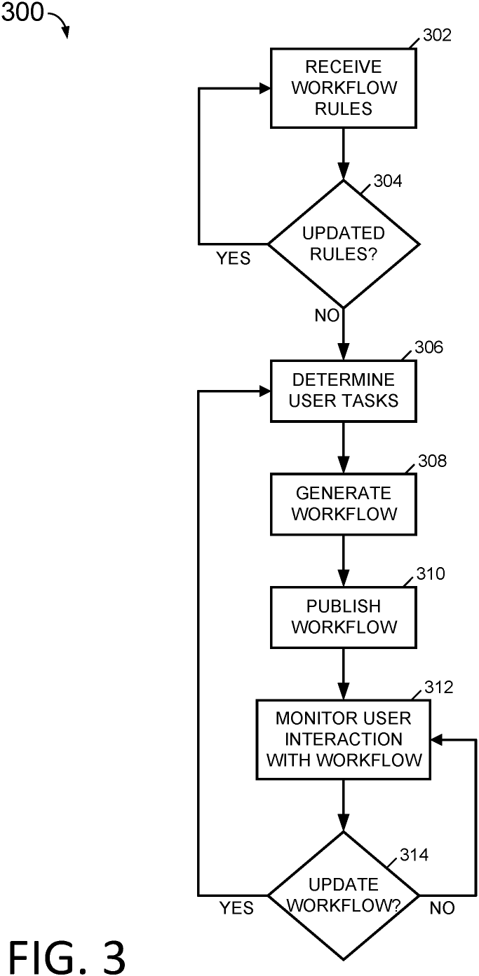

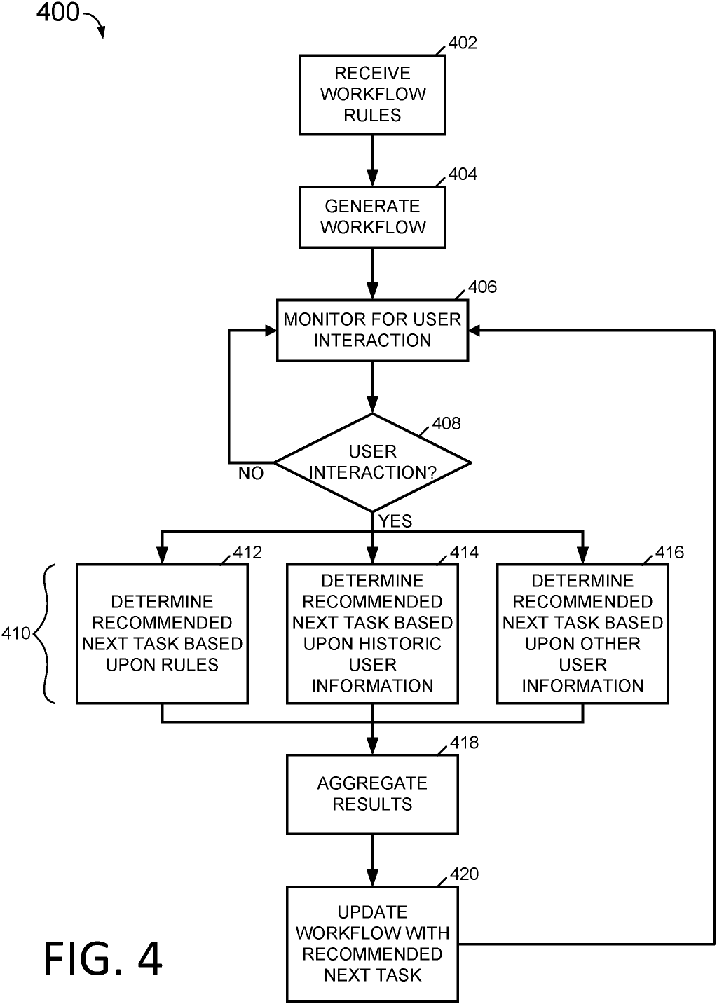

For example, if the desired end product is an approved piece of code, the workflow generator 204 can determine that the tasks include receiving updated code from the user, receiving an indication of one or more supervisors to review the code, providing notification to the one or more supervisors that the code is to be reviewed, receiving feedback from the supervisors the code has been reviewed, providing notification to the user that the code has been reviewed, and providing an indication that the workflow is complete. To generate the particular tasks included within the workflow, the workflow generator 204 can access information such as a set of admin rules 210 as defined by, for example, a network or software administrator, a set of historical user data 212 based upon previous user tasks and workflow interactions, and a set of other user data 214. Generation of a workflow, and updating a workflow to include recommended tasks and/or actions, is described below in additional detail in the description of FIGS. 3 and 4.

As further shown in FIG. 2, the workflow publisher 206 can receive the generated workflow from the workflow generator 204. The workflow publisher 206 can be configured to perform one or more publication tasks associated with the workflow. For example, if a notification or other similar alert is to be distributed to one or more users based upon the generated workflow, the workflow publisher 206 can determine what specific notification is to be transmitted and transmit the notification accordingly to the intended recipients. Similarly, if one or more users have access to track the workflow as tasks within the workflow are completed, the workflow publisher 206 can provide updated information related to completion of individual tasks included within the workflow. To provide timely and accurate update information, the workflow publisher 206 can receive user interaction information from the user monitor 208. As described herein, the user monitor 208 can be configured to monitor user interaction with, for example, the primary application 102 as the user completes one or more tasks associated with the generated workflow. As the user and/or other users associated with the workflow complete one or more tasks, the user monitor 208 can determine that such tasks have been completed and provided an indication to the workflow publisher 206. Based upon these indications, the workflow publisher 206 can provide updates to the one or more users via, for example, updates displayed within the primary application 102 as described herein and shown in FIG. 1.

### Workflow Generation Process

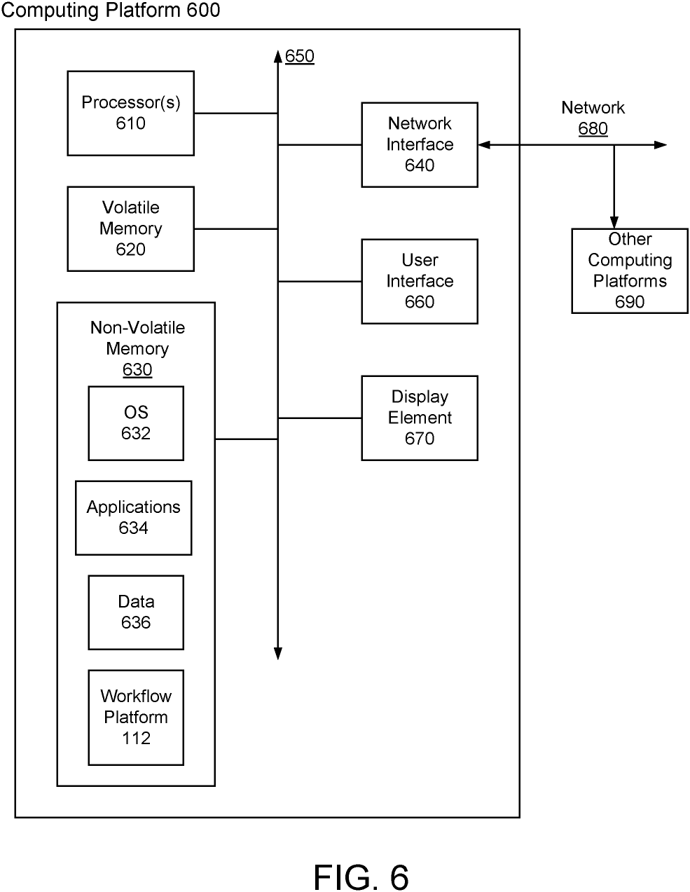

As described above, some examples of the system 100 of FIG. 1 are configured to perform a process for generating a workflow including multiple microapps and tracking progress through the workflow as one or more users interact with the workflow. The processes may be executed on a processor of any suitable type (e.g., processor 610 as shown in FIG. 6 and described hereinbelow). The processes may further be implemented through execution of a web browser plug-in or extension.

FIG. 3 is a flow diagram of a process 300 for generating a workflow and tracking user interaction with the workflow as one or more users complete tasks associated with the workflow. The process 300 can be executed by, for example, a system, processor, or other similar computing device configured to execute one or more instructions for implementation of workflow platform as shown in FIG. 1, or the sub-components thereof as shown in FIG. 2, in accordance with an example of the present disclosure.

As shown in FIG. 3, the process 300 can begin when the system receives 302 one or more workflow rules as defined by, for example, a system administrator as described herein. Prior to receiving, or when receiving, a request for a new workflow, the system can determine 304 if there are any available updated rules for generating the workflow. If the system determines 304 that there are updated rules, the system can receive 302 the updated workflow rules from, for example, the system administrator. If the system determines 304 that there are no updated rules, the system can determine 306 one or more user tasks associated with a particular workflow to generate. For example, as described above, if the workflow is related to receiving approval for an updated piece of software code, the determined 306 user tasks can include receive updated code, determine one or more users to review the updated code, receive feedback from the one or more reviewers, provide feedback to the original user, and receive indication that the code has been finalized.

Based upon the determined 306 user tasks associated with the workflow, the system can generate 308 the workflow to include a structured list of tasks to be completed in order to finish the workflow. Once the workflow has been generated, the system can publish 310 the workflow. For example, publishing 310 the workflow can include the system sending one or more notifications to one or more users associated with completion of at least one task included within the workflow. In some examples, the system can be configured to publish 310 notification of the generated workflow to all users assigned a task within the workflow when the workflow is generated. In other examples, the system can be configured to publish 310 a notification to a particular user when they are assigned to complete the next task within the workflow.

As further shown in FIG. 3, once the workflow has been published 310, the system can monitor 312 user interaction with the workflow. For example, the system can monitor 312 when the user has access to a particular microapp associated with the task included within the workflow and has used the microapp to complete or advance at least one task included within the workflow. Based upon the monitored 312 user interaction with the workflow, the system can determine 314 whether to update the workflow. For example, if the monitored 312 user interaction provides an indication that at least one of the tasks included in the workflow has been completed, the system can determine 314 that an update to the workflow is required. Similarly, if the system monitors 312 the user interaction and determines that the user has completed a task that was not specifically listed on the workflow but may impact tasks that were included on the workflow, the system can determine 314 that the workflow is to be updated. Conversely, if the system monitors 312 user interactions that are unrelated to the workflow or any tasks contained within the workflow, the system can determine 314 that no updates to the workflow are required and can continue to monitor 312 the user.

For example, if, during a code review task, the reviewer provides an indication that additional revisions are required prior to finalizing a piece of code, the system can determine 314 than an update is to be included within the workflow and can determine 306 one or more additional user tasks to include within the workflow. As before, based upon the determined 306 user tasks to be added to the workflow, the system can generate 308 an updated workflow, publish 310 the updated workflow, and monitor 312 user interaction with the updated workflow. Conversely, if the system determines 314 that no updates to the workflow are to be generated, the system can continue to monitor 312 user interaction with the workflow until the workflow is completed or an update to the workflow is to be generated as described herein.

FIG. 4 is a flow diagram of a process 400 for generating a recommended task to include in a workflow based upon a user’s previous interaction with or completion of a task as included in the workflow. The process 400 can be executed by, for example, a system, processor, or other similar computing device configured to execute one or more instructions for implementation of workflow platform as shown in FIG. 1, or the sub-components thereof as shown in FIG. 2, in accordance with an example of the present disclosure.

As shown in FIG. 4, the process 400 can begin when the system receives 402 workflow rules as described above. Based upon the received 402 workflow rules, the system can generate 404 a workflow to complete one or more defined tasks as described herein. Once the workflow has been generated, the system can monitor 406 for user interaction with the workflow. If the system does not determine 408 that a user has interacted with one or more tasks associated with the workflow, the system can continue to monitor 406 for user interaction with the workflow. Conversely, if the system does determine 408 that a user has interacted with one or more tasks associated with the workflow, the system can determine 410 one or more additional recommended tasks to include in the workflow based upon the users monitored interaction. In certain implementations, the system can also determine that one or more tasks are to be pruned or otherwise removed from the workflow. For example, if the system determines that a user has performed a task listed early in the workflow that renders a task later in the workflow as obsolete, the system can prune the obsolete task from the workflow.

As further shown in FIG. 4, the system can perform multiple determination 410 processes to generate one or more recommended tasks to be included in the workflow. For example, the system can determine 412 a recommended next task based upon the original rules as received from, for example, the system administrator. In such an example, the rules can include a set task that is assigned to follow user interaction with or completion of a task as included in the workflow. Similarly, the system can be configured to determine 414 a recommended next task based upon historic user information for the user that has interacted with or completed the task. For example, such a system can be referred to as a content-based filtering system for additional recommended tasks. The content-based filtering system can use the history of actions taken by the user to recommend the next course of action. For example, if a user consistently performs a particular task following completion of another task, the system can determine 414 the recommended next task based upon the user’s historical tendencies as indicated by the content-based filtering system. As further shown in FIG. 4, the system can determine 416 a recommended next task based upon other user information. For example, such a system can be referred to as a collaborative-based filtering system. The collaborative-based filtering system can use the history of actions taken by other users of the system to recommend the next course of action. For example, if a specific team or group of employees has their own set of workflow rules or a historic tendency to perform a particular task that is unique to their group, the system can determine 416 the recommended next task based upon results of the collaborative-based filtering system.

Once the system has determined 410 one or more recommended next tasks, the system can aggregate 418 the results of the determination steps. To aggregate 418 the recommended next tasks, the system can use one or more arbitration processes to rank the weight of each recommended next task and assign a recommended task accordingly. For example, the following sample arbitration process can be used:

while (user takes an action)
{
update the weighted averages for each filter based upon the user action
record the action taken
update the content-based filter with the user’s action and update weighted
average
update the collaborative-based filter with the user’s action and update weighted
average
calculate the next potential action based upon the weight averages of the filters
recommend the next course of action
}

Initially, each of the content-based filter and collaborative-based filter can have a weighted average at or near zero. In such an example, as a new user interacts with the system, the rules as set by the system administrator will likely dictate what tasks are recommended to the user. However, as the user continues to interact with the system, the system can record how the user typically reacts to a completed task. Similarly, the system can determine how the user’s action compares to those of other users of the system. Based upon such determination, the system can adjust the user’s content-based filter weighted average and the user’s collaborative-based filter weighted average. As such, over time, the recommended next tasks can be based upon the output of one or more of the content-based filter and the collaborative-based filter.

Referring back to FIG. 4, once the system has aggregated 418 the recommended tasks, the system can update 420 the workflow with the recommended next task. The system can continue to monitor 406 for user interaction with the workflow until the workflow has been completed.

To provide a specific example, the rules as defined by the system administrator for, for example, requesting a day off may include a user contacting a human resources manager, the user contacting their direct manager, and the user updating a calendar application to reflect the time off (if approved). Over time, a user may continually update an out-of-office message as well when updating their calendar application. In such an example, the system can use the process 400 as shown in FIG. 4 and described above to update the standard workflow for the user when requesting time off to include a task related to updating their out of office message immediately prior to the requested time off beginning. Such an update can be based upon updating the content-based filter weighted average over time as the user completes workflows associated with requesting time off.

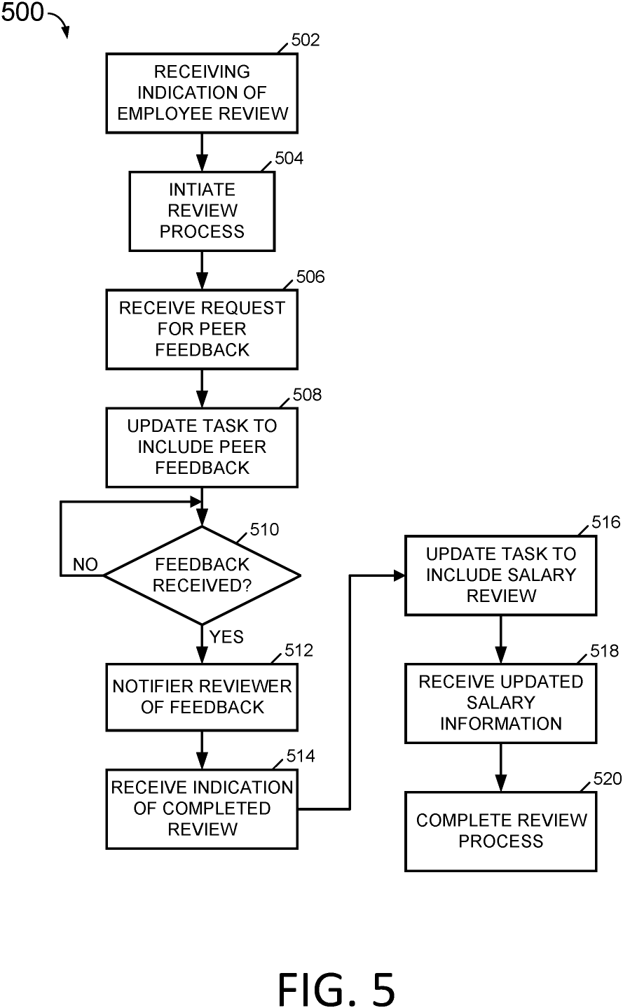

FIG. 5 illustrates a sample process 500 for using multiple microapps to complete a particular task as defined by a workflow generated as described herein. The process 500 can be implemented by, for example, a system, processor, or other computing device configured to implement the workflow platform 112 as shown in FIG. 1 and described hereinabove. In this example, the process 500 includes a sample flow chart for performing an employee review that includes both accessing a human resource management application/microapp as well as a financial management application/microapp within a single workflow.

As shown in FIG. 5, the process 500 can begin when the system receives 502 an indication of an employee review and receives an associated workflow defining the tasks to be completed. The system can initiate 504 the review process by, for example, providing an indication of a task to be completed to the reviewer. The indication can include that the reviewer is to access the human resources management application/microapp to complete a review for a particular employee. During the review, the reviewer can request additional peer feedback related to the employee being reviewed. The system can receive 506 the request for peer feedback and update 508 the workflow to include a task associated with collecting the peer feedback. In such an example, one or more additional reviewers associated with the request for the peer review information can receive an automatic notification from the system implementing the workflow platform that they have been assigned a task associated with the workflow. In response to opening the notification, the human resource management application/microapp can be automatically launched on the additional reviewers’ computers, and the additional reviewers can be automatically directed to one or more forms for providing the peer feedback for the employee being reviewed.

As further shown in FIG. 5, the system can determine 510 whether the additional feedback has been received from the peer reviewers. If the system determines 510 that the additional feedback has not been received, the system can continue to monitor for the additional peer feedback from the additional reviewers. Conversely, if the system does determine 510 that the additional peer review feedback has been received, the system can provide a notification 512 to the original reviewer that the peer feedback has been received. Additionally, the notification can include an option to launch the human resource management application/microapp such that the original reviewer can access any information previously entered, as well as the received peer review information from the additional reviewers. Using this information, the original reviewer can complete the review of the employee using the human resource management application/microapp.

Upon completion of the review, the system can receive 514 an indication that the review has been completed by the original reviewer. The system can update 516 the workflow to indicate that the next task includes a salary review. The system can provide a notification to a user assign the next task, the notification including an option to automatically launch, for example, a financial management application/microapp to complete the salary review information based upon the employee review information as received above. Once the next task including the salary review has been completed, the system can receive 518 an indication that the salary review has been completed. Once such a task update has been received, the system can complete 520 the review process and provide an indication to one or more users that the workflow has been completed.

It should be noted that the example process 500 as shown in FIG. 5 has been simplified to include two distinct applications and/or microapps by way of example only. In certain implementations, three or more micro apps can be included in a single workflow depending upon the type of tasks included within the workflow. For example, when using the workflow platform as described herein to generate and monitor user progression through a workflow associated with updating one or more pieces of code, a set of applications and/or microapps can include an issue tracking system application/microapp, a source code management system application/microapp, a build system application/microapp, a review system application/microapp, a documentation system application/microapp, and other similar applications and/or microapps associated with code generation, review, and publication.

It should also be noted that the process orders as shown in FIGS. 3, 4, and 5 and described herein are provided by way of example only. Depending upon the implementation of the processes as described herein, the individual process steps can be altered or otherwise changed.

### Computing Platform for Workflow Generation and Implementation

FIG. 6 is a block diagram of a computing platform 600 configured to perform a process for generating and updating a task-based workflow, in accordance with an example of the present disclosure. In some cases, the platform 600 may be a workstation, server, laptop, mobile device, or smartphone.

The computing platform or device 600 includes one or more processors 610, volatile memory 620 (e.g., random access memory (RAM)), non-volatile memory 630, one or more network or communication interfaces 640, user interface (UI) 660, display element (e.g., screen) 670, and a communications bus 650. The computing platform 600 may also be referred to as a computer or a computer system.

The non-volatile (non-transitory) memory 630 can include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 660 can include one or more input/output (I/O) devices (e.g., a mouse, a keyboard, a microphone, one or more speakers, one or more biometric scanners, one or more environmental sensors, and one or more accelerometers, etc.).

The display element 670, can provide a graphical user interface (GUI) and in some cases, may be a touchscreen or any other suitable display device.

The non-volatile memory 630 stores an operating system 632, one or more applications 634 (including web browsers), data 636, and elements of the workflow platform 112 of FIG. 1, such that, for example, computer instructions of the operating system 632, the applications 634, and the elements of the workflow platform 112, are executed by processor(s) 610 out of the volatile memory 620. In some examples, the volatile memory 620 can include one or more types of RAM and/or a cache memory that can offer a faster response time than a main memory. Data can be entered through the user interface 660. Various elements of the computer 600 can communicate via the communications bus 650.

The illustrated computing platform 600 is shown merely as an example client device or server and can be implemented by any computing or processing environment with any type of machine or set of machines that can have suitable hardware and/or software capable of operating as described herein.

The processor(s) 610 can be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations can be hard coded into the circuitry or soft coded by way of instructions held in a memory device and executed by the circuitry. A processor can perform the function, operation, or sequence of operations using digital values and/or using analog signals.

In some examples, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multicore processors, or general-purpose computers with associated memory.

The processor 610 can be analog, digital, or mixed. In some examples, the processor 610 can be one or more physical processors, or one or more virtual (e.g., remotely located or cloud) processors. A processor including multiple processor cores and/or multiple processors can provide functionality for parallel, simultaneous execution of instructions or for parallel, simultaneous execution of one instruction on more than one piece of data.

The network interfaces 640 can include one or more interfaces to enable the computing platform 600 to access a computer network 680 such as a Local Area Network (LAN), a Wide Area Network (WAN), a Personal Area Network (PAN), or the Internet through a variety of wired and/or wireless connections, including cellular connections. In some examples, the network 680 may allow for communication with other computing platforms 690, to enable distributed computing.

In described examples, the computing platform 600 can execute an application on behalf of a user of a client device. For example, the computing platform 600 can execute one or more virtual machines managed by a hypervisor. Each virtual machine can provide an execution session within which applications execute on behalf of a user or a client device, such as a hosted desktop session. The computing platform 600 can also execute a terminal services session to provide a hosted desktop environment. The computing platform 600 can provide access to a remote computing environment including one or more applications, one or more desktop applications, and one or more desktop sessions in which one or more applications can execute.

Having thus described several aspects of at least one example, it is to be appreciated that various alterations, modifications, and improvements will readily occur to those skilled in the art. For instance, examples disclosed herein can also be used in other contexts. Such alterations, modifications, and improvements are intended to be part of this disclosure and are intended to be within the scope of the examples discussed herein. Accordingly, the foregoing description and drawings are by way of example only.

Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

1. A computer system comprising:
a memory; and
at least one processor operably coupled to the memory and configured to:
receive a set of rules for generating a workflow that chains one or more tasks associated with one or more applications into the workflow;
receive an indication of a task to be completed;
generate a task-based workflow for the task to be completed based upon the set of rules, wherein the task-based workflow provides one or more users with an indication of a task to be completed and which of the one or more applications to use to complete the task;
monitor interaction between the one or more users and the task-based workflow;
update the task-based workflow to indicate one or more completed tasks based upon the monitored interaction to create an updated workflow; and
provide an indication of the updated workflow to the one or more users.

2. The computer system of claim 1, wherein the at least one processor being configured to monitor interaction between the one or more users and the task-based workflow comprises the at least one processor being further configured to:
monitor interaction between the one or more users and a microapp associated with at least one task in the task-based workflow;
determine that the one or more users have completed the at least one task in the task-based workflow by performing one or more actions within the microapp associated with the at least one task; and
receive an indication that the at least one task in the task-based workflow has been completed.

3. The computer system of claim 1, wherein the at least one processor being configured to update the task-based workflow comprises the at least one processor being further configured to:
determine an action taken by at least one of the one or more users;
determine at least one additional task to add to the workflow based upon the action taken by the at least one of the one or more users; and
update the task-based workflow to include the at least one additional task.

4. The computer system of claim 1, the at least one processor further configured to:
receive an updated set of rules;
generate an updated task-based workflow based upon the update set of rules; and
provide notification to the one or more users of the updated task-based workflow.

5. The computer system of claim 1, the at least one processor being further configured to:
determine an action taken by at least one of the one or more users when completing at least one task in the task-based workflow;
determine a recommended task to include in the workflow based upon the action of taken by the at least one of the one or more users; and
provide a recommendation to the at least one of the one or more users to include the recommended task in the workflow.

6. The computer system of claim 5, wherein the at least one processor being configured to determine a recommended task to include in the workflow comprises the at least one processor being further configured to:
determine a first recommended task based upon the set of rules;
determine a second recommended task based upon historic use information for the at least one of the one or more users;
determine a third recommended task based upon information for system users other than the at least one of the one or more users; and
compare the first recommended task, the second recommended task, and the third recommended task to determine the recommended task to provide to the at least one of the one or more users.

7. The computer system of claim 6, wherein the at least one processor being configured to compare the first recommended task, the second recommended task, and the third recommended task comprises the at least one processor being further configured to:
determine a first weighted average associated with the first recommended task;
determine a second weighted average associated with the second recommended task;
determine a third weighted average associated with the third recommended task; and
compare the first weighted average, the second weighted average, and the third weighted average.

8. A method of creating workflows by chaining microapps in a workspace platform, the method comprising:
receiving a set of rules for generating a workflow that chains one or more tasks associated with one or more applications into the workflow;
receiving an indication of a task to be completed;
generating a task-based workflow for the task to be completed based upon the set of rules, wherein the task-based workflow provides one or more users with an indication of a task to be completed and which of the one or more applications to use to complete the task;
monitoring interaction between the one or more users and the task-based workflow;
updating the task-based workflow to indicate one or more completed tasks based upon the monitored interaction to create an updated workflow; and
providing an indication of the updated workflow to the one or more users.

9. The method of claim 8, wherein monitoring the interaction between the one or more users and the task-based workflow comprises:
monitoring interaction between the one or more users and a microapp associated with at least one task in the task-based workflow;
determining that the one or more users have completed the at least one task in the task-based workflow by performing one or more actions within the microapp associated with the at least one task; and
receiving an indication that the at least one task in the task-based workflow has been completed.

10. The method of claim 8, wherein updating the task-based workflow comprises:
determining an action taken by at least one of the one or more users;
determining at least one additional task to add to the workflow based upon the action taken by the at least one of the one or more users; and
updating the task-based workflow to include the at least one additional task.

11. The method of claim 8, further comprising:
receiving an updated set of rules;
generating an updated task-based workflow based upon the update set of rules; and
providing notification to the one or more users of the updated task-based workflow.

12. The method of claim 8, further comprising:
determining an action taken by at least one of the one or more users when completing at least one task in the task-based workflow;
determining a recommended task to include in the workflow based upon the action of taken by the at least one of the one or more users; and
providing a recommendation to the at least one of the one or more users to include the recommended task in the workflow.

13. The method of claim 12, wherein determining a recommended task to include in the workflow comprises:
determining a first recommended task based upon the set of rules;
determining a second recommended task based upon historic use information for the at least one of the one or more users;
determining a third recommended task based upon information for system users other than the at least one of the one or more users; and
comparing the first recommended task, the second recommended task, and the third recommended task to determine the recommended task to provide to the at least one of the one or more users.

14. The method of claim 13, wherein comparing the first recommended task, the second recommended task, and the third recommended task comprises:
determining a first weighted average associated with the first recommended task;
determining a second weighted average associated with the second recommended task;
determining a third weighted average associated with the third recommended task; and
comparing the first weighted average, the second weighted average, and the third weighted average.

15. A non-transitory computer readable medium storing computer executable sequences of instructions to create workflows by chaining microapps in a workspace platform, the sequences of instructions comprising instructions to:
receive a set of rules for generating a workflow that chains one or more tasks associated with one or more applications into the workflow;
receive an indication of a task to be completed;
generate a task-based workflow for the task to be completed based upon the set of rules, wherein the task-based workflow provides one or more users with an indication of a task to be completed and which of the one or more applications to use to complete the task;
monitor interaction between the one or more users and the task-based workflow;
update the task-based workflow to indicate one or more completed tasks based upon the monitored interaction to create an updated workflow; and
provide an indication of the updated workflow to the one or more users.

16. The non-transitory computer readable medium of claim 15, wherein the instructions to monitor the interaction between the one or more users and the task-based workflow comprise instructions to:
monitor interaction between the one or more users and a microapp associated with at least one task in the task-based workflow;
determine that the one or more users have completed the at least one task in the task-based workflow by performing one or more actions within the microapp associated with the at least one task; and
receive an indication that the at least one task in the task-based workflow has been completed.

17. The non-transitory computer readable medium of claim 15, wherein the instructions to update the task-based workflow comprise instructions to:
determine an action taken by at least one of the one or more users;
determine at least one additional task to add to the workflow based upon the action taken by the at least one of the one or more users; and
update the task-based workflow to include the at least one additional task.

18. The non-transitory computer readable medium of claim 15, wherein the sequences of instructions further comprise instructions to:
receive an updated set of rules;
generate an updated task-based workflow based upon the update set of rules; and
provide notification to the one or more users of the updated task-based workflow.

19. The non-transitory computer readable medium of claim 15, wherein the sequences of instructions further comprise instructions to:
determining an action taken by at least one of the one or more users when completing at least one task in the task-based workflow;
determining a recommended task to include in the workflow based upon the action of taken by the at least one of the one or more users; and
providing a recommendation to the at least one of the one or more users to include the recommended task in the workflow.

20. The non-transitory computer readable medium of claim 19, wherein the instructions to determine a recommended task to include in the workflow comprise instructions to:
determine a first recommended task based upon the set of rules;
determine a second recommended task based upon historic use information for the at least one of the one or more users;
determine a third recommended task based upon information for system users other than the at least one of the one or more users; and
compare the first recommended task, the second recommended task, and the third recommended task to determine the recommended task to provide to the at least one of the one or more users.

21. The non-transitory computer readable medium of claim 20, wherein the instructions to compare the first recommended task, the second recommended task, and the third recommended task comprise instructions to:
determine a first weighted average associated with the first recommended task;
determine a second weighted average associated with the second recommended task;
determine a third weighted average associated with the third recommended task; and
compare the first weighted average, the second weighted average, and the third weighted average.
